(19) United States
(12) Patent Application Publication
(10) Pub. No.: US 2009/0290175 A1
(43) Pub. Date: Nov. 26, 2009

(54) METHOD AND APPARATUS FOR PRINTING DOCUMENT INCLUDING OBJECT TO WHICH PREDETERMINED EFFECT IS APPLIED

(75) Inventor: Hyun-seung LEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/389,924

(22) Filed: Feb. 20, 2009

(30) Foreign Application Priority Data
May 23, 2008 (KR) 10-2008-0048064

(51) Int. Cl. H04N 1/60; G06F 3/12; G06K 9/36

(52) U.S. Cl. 358/1.9; 358/1.15; 382/285

(57) ABSTRACT

Provided are a printing method and apparatus. The printing method includes receiving data regarding a document to be printed from a host, applying a predetermined effect to an object included in the document to be printed, and printing the document including the object to which the predetermined effect is applied. Thus, when a document created by a host and transmitted to a printing apparatus to be printed, cannot be corrected by the host, an effect can be applied to the document by the printing apparatus.

### CROSS-REFERENCE TO RELATED PATENT APPLICATION

This application claims the benefit of Korean Patent Application No. 10-2008-0048064, filed on May 23, 2008, in the Korean Intellectual Property Office, the disclosure of which is incorporated herein in its entirety by reference.

### BACKGROUND OF THE INVENTION

1. Field of the Invention

Apparatus and method consistent with the present invention relate to printing and more particularly, to printing a document including an object to which a predetermined effect is applied.

2. Description of the Related Art

Hosts and printing apparatuses are essential to recent office automation equipment. A document written in a host, that is, a computer, is printed by a printing apparatus connected directly to the computer or connected via a network. When a host transmits data regarding a document to be printed, which is encoded using a page description language (PDL) according to a manufacturer and a printing form, to a printing apparatus, the printing apparatus receives and prints the data. This process will be described with reference to FIG. 1.

FIG. 1 is a block diagram of a conventional printing system.

A printing apparatus 100 receives data regarding a document to be printed from a host 1 10. The host 110 may be a computer in which a driver of the printing apparatus 100 is installed, wherein the driver of the printing apparatus can encode a document to be printed using a predetermined PDL. Various PDLs such as PCL5e, PCL XL, Postscript, PCL-GUI, PCLXL, HPGL, ESC/P2, ESC/PAGE, ESC/PAGE-COLOR, etc. can be used to encode the document to be printed according to a printing feature and features of the printing apparatus 100.

An emulation unit 102 of the printing apparatus 100 receives the data regarding the document to be printed from the host 110, and forms the document to be printed using the above-described PDL. The document to be printed is formed by objects, that is, information regarding text, graphics, images, etc., according to the sizes and locations of the objects. The emulation unit 102 decodes the data and arranges the objects on the document so as to form the document to be printed.

A printing unit 104 prints the document formed by the emulation unit 102. In the conventional printing system of FIG. 1, the printing apparatus 100 prints the data regarding the document to be printed, which is transmitted from the host 110. That is, in order for a user to correct the document to be printed, the document to be printed needs to be corrected using the host 110. Thus, when the document to be printed cannot be corrected using the host 110 like in the case where the document is a PDF document, the document to be printed is printed without correction of the document.

### SUMMARY OF THE INVENTION

The present invention provides a method and apparatus for printing a document to which a predetermined effect that cannot be applied by a host is applied by a printing apparatus. In addition, the present invention also provides a computer readable recording medium having recorded thereon a program for executing the method.

According to an aspect of the present invention, there is provided a printing method comprising receiving data regarding a document to be printed from a host, and forming the document to be printed, based on the received data; applying a predetermined effect to an object included in the document to be printed; and printing the document comprising the object to which the predetermined effect is applied.

The predetermined effect may comprise a boundary effect applied to a boundary of the object.

The object may comprise at least one of a text, a graphic and an image.

The receiving of the data may comprise receiving the data regarding the document to be printed, which is encoded using a page description language (PDL); and decoding the received data by using the page description language to form the document to be printed.

The applying of the predetermined effect may comprise detecting a boundary of the object included in the document to be printed by using a predetermined filter; and applying a predetermined boundary effect to the detected boundary.

The detecting of the boundary may comprise detecting the boundary of the object included in the document to be printed by using a sobel filter or a prewitt filter.

The applying of the boundary effect comprises selecting an object to which the predetermined boundary effect is applied from among a plurality of objects included in the document to be printed; and applying the boundary effect to the selected object.

The applying of the predetermined boundary effect may comprise selecting a boundary to which the predetermined boundary effect is applied, according to a location and size of the object, which is obtained by encoding the received data by using the page description language; and applying the boundary effect to the selected boundary.

The predetermined boundary effect may comprise at least one of an outline effect, a shadow effect and a 3-dimensional effect.

According to another aspect of the present invention, there is provided a printing apparatus comprising an emulation unit which receives data regarding a document to be printed from a host, and forms the document to be printed, based on the received data; and an effect applying unit which applies a predetermined effect to an object included in the document to be printed; and a printing unit which prints the document comprising the object to which the predetermined effect is applied.

According to another aspect of the present invention, there is provided a computer readable recording medium having recorded thereon a program for executing the above method.

### BRIEF DESCRIPTION OF THE DRAWINGS

The above and other features and aspects of the present invention will become more apparent by describing in detail exemplary embodiments thereof with reference to the attached drawings in which:

FIG. 1 is a block diagram of a conventional printing system.

FIG. 2 is a block diagram of a printing apparatus according to an exemplary embodiment of the present invention;

FIG. 3 is a block diagram of an effect applying unit of the printing apparatus illustrated in FIG. 2, according to an exemplary embodiment of the present invention;

FIG. 4 illustrates a boundary effect, according to an exemplary embodiment of the present invention; and

FIG. 5 is a flowchart of a printing method according to an exemplary embodiment of the present invention.

### DETAILED DESCRIPTION OF EXEMPLARY EMBODIMENTS OF THE INVENTION

Hereinafter, the present invention will be described in detail with reference to the accompanying drawings, in which exemplary embodiments of the invention are shown.

FIG. 2 is a block diagram of a printing apparatus 200 according to an embodiment of the present invention.

Referring to FIG. 2, the printing apparatus 200 according to the current embodiment of the present invention includes an emulation unit 210, an effect applying unit 220 and a printing unit 230.

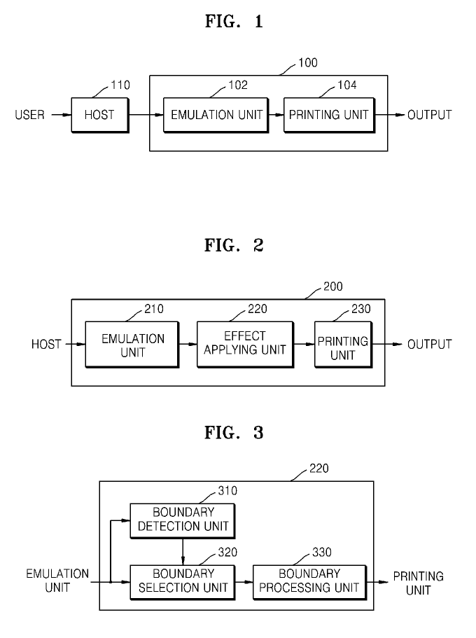

The emulation unit 210 receives data regarding a document to be printed from a host, and decodes the received data by using a predetermined page description language (PDL) so as to form the document to be printed. The emulation unit 210 corresponds to the emulation unit 102 illustrated in FIG. 1. Thus, the emulation unit 210 decodes objects included in the document to be printed, that is, information regarding text, graphics, images, etc., according to the sizes and locations of the objects by using a predetermined PDL. The document to be printed is formed by arranging the objects according to the decoded sizes and locations.

The effect applying unit 220 applies a predetermined effect to the objects included in the document formed by the emulation unit 210. The color or size of at least one object from among the text, the graphics and the images may be corrected. When the object is text, various effects such as Italic, bold, etc. may be applied. When the object is an image, effects such as contrast, brightness and sharpness of the image may be applied. Graphics represent an object that can be represented by a numerical formula with a vector. An image that can be expressed by points, lines and surfaces, and represented by a numerical formula, is referred to as a graphic. On the other hand, a natural image is an image object that cannot be expressed by points, lines and surfaces, unlike the case of a graphic.

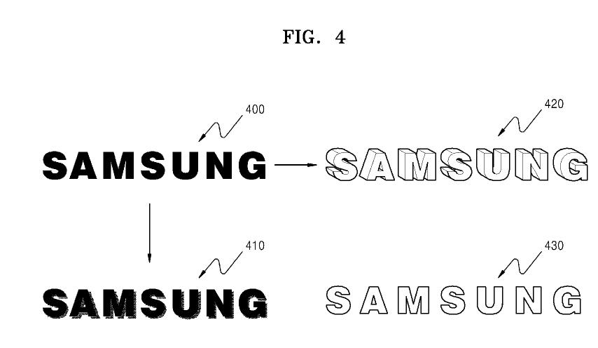

The effect applying unit 220 may apply various effects in addition to the above-described effects to the objects included in the document to be printed, which is formed in the emulation unit 210. In particular, a predetermined boundary effect may be applied to a boundary of the object, which will be described with reference to FIGS. 3 and 4.

FIG. 3 is a block diagram of the effect applying unit 220 included in the printing apparatus 200 illustrated in FIG. 2, according to an exemplary embodiment of the present invention.

Referring to FIG. 3, the effect applying unit 220 applying a boundary effect according to the present embodiment includes a boundary detection unit 310, a boundary selection unit 320 and a boundary processing unit 330.

The boundary detection unit 310 detects boundaries of the objects included in the document to be printed, which is formed by the emulation unit 210. Information regarding the locations and sizes of the objects included in the document may be extracted using a PDL. A boundary to which the boundary effect is to be applied is detected based on the location and sizes of the objects. The objects may be filtered by a sobel filter or a prewitt filter, used to detect an edge, so as to detect the boundary of the objects.

The boundaries inside the objects as well as outlines of the objects can be detected. When the objects are images, there may be boundaries dividing the images. Thus, the boundaries can be detected using the above-described filters, i.e., a sobel filter or a prewitt filter.

The boundary selection unit 320 selects a boundary to which the boundary effect is applied from among the boundaries detected by the boundary detection unit 310. When the document to be printed includes a plurality of objects, an object to which the boundary effect is applied is selected from among the objects and a boundary to which a boundary effect is to be applied is selected.

The boundary to which a boundary effect is applied may be selected according to the type of the object, such as text, graphics or an image, or according to the location of the object in the document. For example, only a boundary of the text may be selected as a boundary to which a boundary effect is applied, or alternatively, only a boundary in a first line of the document may be selected as the boundary to which a boundary effect is applied.

A boundary may be set so that only a boundary on a specific side may be selected as a boundary to which the boundary effect is applied, from among the boundaries of the object. Only left, right, upper and lower boundaries may be selected as boundaries to which a boundary effect is applied. In order to apply a boundary effect in a diagonal direction, left upper, left lower, right upper and right lower boundaries may be selected as boundaries to which a boundary effect is applied.

Data regarding the document to be printed is decoded so that a boundary to which a boundary effect is applied may be selected with reference to information regarding the locations and sizes of the objects expressed by a PDL. In addition, as described above, the boundary detected in the boundary detection unit 310 by using a predetermined filter may be selected as a boundary to which a boundary effect is applied.

The boundary processing unit 330 applies a predetermined boundary effect to the boundary selected in the boundary selection unit 320. The predetermined boundary effect such as an outline effect, a shadow effect, a 3-dimension effect, etc. may be applied to the boundary selected in the boundary selection unit 320.

FIG. 4 illustrates a boundary effect according to an exemplary embodiment of the present invention.

Referring to FIG. 4, a shadow effect 410 may be applied to a text object “SAMSUNG” 400 on a right side thereof Alternatively, a 3-dimensional effect 420 may be applied to the text object “SAMSUNG” 400. In addition, an outline effect 430 by which only an outline is indicated may be applied to the text object “SAMSUNG” 400. In FIG. 4, a predetermined boundary effect is applied to the text object “SAMSUNG” 400, but it will be understood by one of ordinary skill in the art that the predetermined boundary effect may also be applied to a graphic object or an image object.

In addition, sides on which the shadow effect 410 and/or the 3-dimensional effect 420 are/is applied are not limited to the sides illustrated in FIG. 4. That is, the shadow effect 410 and/or the 3-dimensional effect 420 may be applied on various sides of the text object “SAMSUNG” 400. For example, the shadow effect 410 may be applied on a left lower side, and the 3-dimensional effect 420 may be applied on a right upper side. With regard to the outline effect 430, a boundary may be indicated as a solid line, as illustrated in FIG. 4, or alternatively, may be indicated as a dotted line. In addition, a plurality of solid lines or dotted lines may be used to indicate the boundary instead of a single solid line or dotted line.

Referring back to FIG. 2, the printing unit 230 prints the document including the object to which the predetermined boundary effect is applied by the effect applying unit 220.

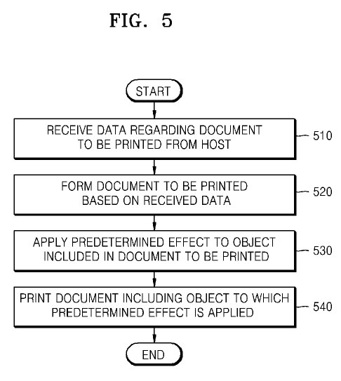

FIG. 5 is a flowchart of a printing method according to an exemplary embodiment of the present invention.

Referring to FIG. 5, in operation 510, a printing apparatus according to the present embodiment receives data regarding a document to be printed from a host. The data regarding the document is encoded by the host by using a predetermined PDL, and includes the locations and sizes of objects of the document to be printed. The objects of the document to be printed may include at least one of text, graphics and images.

In operation 520, the printing apparatus decodes the data regarding the document to be printed, which is received from the host, so as to form the document to be printed. The document is formed by decoding the data regarding the document to be printed using a predetermined PDL. According to the locations and sizes of the objects included in the document to be printed, the objects are arranged so as to form the document.

In operation 530, the printing apparatus applies a predetermined effect to an object included in the document to be printed, which is formed in operation 520. A predetermined boundary effect may be applied to a boundary of the object. At least one of a shadow effect, a 3-dimensional effect and an outline effect, which have been described with reference to FIG. 4, may be applied to the boundary of the object.

A boundary, which cannot be detected using a PDL, is detected by an edge detection filter such as a sobel filter or a prewitt filter. That is, since a boundary inside an image object cannot be detected using the sizes and locations of the objects described using a PDL, the above-described filter may be used to detect a boundary inside the image object.

Some of a plurality of objects included in the document to be printed may be selected for applying a boundary effect to a boundary of the objects. As described above, a boundary to which a boundary effect is applied is selected according to the type of object, such as text, graphics or images. Alternatively, a boundary to which a boundary effect is applied may be selected according to the location of the object in the document. For example, only a boundary of a text object may be selected as a boundary to which a boundary effect is applied, and alternatively, only a boundary of a first line of the document may be selected as a boundary to which a boundary effect is applied.

A boundary side is set, and then only a predetermined side of a boundary may be selected as a boundary to which a boundary effect is applied, from among the boundaries of the object. Only left, right, upper and lower boundaries may be selected as boundaries to which a boundary effect is applied. In order to apply a boundary effect in a diagonal direction, a boundary effect may be applied to only left upper, left lower, right upper and right lower boundaries.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

According to the above exemplary embodiments of the present invention, when a host transmits data regarding a document to be printed a to a printing apparatus, while the document cannot be corrected by the host, a printing apparatus can directly apply a predetermined effect to objects included in the document, and thus various effects can be realized.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A printing method comprising:
receiving data regarding a document to be printed from a host, and forming the document to be printed, based on the received data;
applying an effect to an object included in the document to be printed; and
printing the document comprising the object to which the effect is applied,
wherein the effect comprises a boundary effect applied to a boundary of the object.

2. The method of claim 1, wherein the object comprises at least one of a text, a graphic and an image.

3. The method of claim 1, wherein the receiving of the data comprises:
receiving the data regarding the document to be printed, which is encoded using a page description language (PDL); and
decoding the received data by using the page description language to form the document to be printed.

4. The method of claim 1, wherein the applying of the effect comprises:
detecting a boundary of the object included in the document to be printed by using a specific filter; and
applying the boundary effect to the detected boundary.

5. The method of claim 4, wherein the detecting of the boundary comprises detecting the boundary of the object included in the document to be printed by using a sobel filter or a prewitt filter.

6. The method of claim 1, wherein the applying of the boundary effect comprises:
selecting the object to which the boundary effect is applied from among a plurality of objects included in the document to be printed; and
applying the boundary effect to the selected object.

7. The method of claim 1, wherein the applying of the boundary effect comprises:
selecting the boundary to which the boundary effect is applied, according to a location and size of the object, which is obtained by decoding the received data by using a page description language (PDL); and
applying the boundary effect to the selected boundary.

8. The method of claim 4, wherein the boundary effect comprises at least one of an outline effect, a shadow effect and a 3-dimensional effect.

9. A printing apparatus comprising:
an emulation unit which receives data regarding a document to be printed from a host, and forms the document to be printed, based on the received data; and
an effect applying unit which applies an effect to an object included in the document to be printed; and
a printing unit which prints the document comprising the object to which the effect is applied,
wherein the effect comprises a boundary effect applied to a boundary of the object.

10. The apparatus of claim 9, wherein the object comprises at least one of a text, a graphic and an image.

11. The apparatus of claim 9, wherein the emulation unit receives the data regarding the document to be printed, which is encoded using a page description language, and decodes the received data by using the page description language to form the document to be printed.

12. The apparatus of claim 9, wherein the effect applying unit comprises:
a boundary detection unit which detects a boundary of the object included in the document to be printed by using a specific filter; and
a boundary processing unit which applies the boundary effect to the detected boundary.

13. The apparatus of claim 12, wherein the boundary detection unit detects the boundary of the object included in the document to be printed by using a sobel filter or a prewitt filter.

14. The apparatus of claim 9, wherein the effect applying unit comprises:
a boundary selection unit which selects the object to which the boundary effect is applied from among a plurality of objects included in the document to be printed; and
a boundary processing unit which applies the boundary effect to the selected object.

15. The apparatus of claim 9, wherein the effect applying unit selects the boundary to which the boundary effect is applied, according to a location and size of the object, which is obtained by encoding the received data by using a page description language (PDL), and applies the boundary effect to the selected boundary.

16. The apparatus of claim 9, wherein the boundary effect comprises at least one of an outline effect, a shadow effect and a 3-dimensional effect.

17. A computer readable recording medium having recorded thereon a program which causes a computer to execute the method of claim 1.
